(19) United States
(12) Patent Application Publication
(10) Pub. No.: US 2025/0322763 A1
(43) Pub. Date: Oct. 16, 2025

(54) Real-Time Prompt Generation Using an Artificial Intelligence (AI) Tutoring System

(71) Applicant: 2hr Learning, Inc., Austin, TX (US)

(72) Inventors: Vinayak Sachdeva, Haryana (IN); Bekhruz Toirkhujaev, Tashkent (UZ); Vicky Biswas, Dehradun (IN)

(73) Assignee: 2hr Learning, Inc., Austin, TX (US)

(21) Appl. No.: 19/177,481

(22) Filed: Apr. 11, 2025

Related U.S. Application Data
(60) Provisional application No. 63/632,999, filed on Apr. 11, 2024.

(51) Int. Cl. G09B 7/08; G06F 16/3329

(52) U.S. Cl. CPC G09B 7/08; G06F 16/33295

(57) ABSTRACT

A system integrates an enhanced communication module within an online tutoring platform to establish a communication between the online tutoring platform and an AI tutoring system to enhances the learning experience on the online tutoring platform through contextual content delivery, adaptive and interactive problem-solving guidance, and personalized tutoring of the user. The AI tutoring system receives user data from the user and the ongoing session data. The system comprises a processor to receive the user data and the ongoing session data to parse the received user data and ongoing session data to extract one or more session events. The processor compares the one or more session events to a plurality of pre-defined rules to detect the session event. The AI tutoring system utilizes a LLM to generate a prompt. The chatbot window is used to display the generated prompt on a user interface of the online tutoring platform interface to the user.

### CROSS-REFERENCE TO RELATED APPLICATION

This application claims the benefit under 35 U.S.C. § 119(e) and 37 C.F.R. § 1.78 of U.S. Provisional Application No. 63/632,999, filed Apr. 11, 2024, which is incorporated by reference in its entirety.

### FIELD OF THE INVENTION

The present invention relates in general to the field of electronics, and more specifically to integrating a chatbot between a user interface of an online tutoring platform and an artificial intelligence (AI) tutoring system to provide prompt and real-time guidance to a user while learning on the online tutoring platform.

### BACKGROUND OF THE INVENTION

Digital revolution has transformed the traditional classroom into a dynamic, technology-driven environment. With the proliferation of digital learning platforms and evaluation tools, students are presented with an unprecedented array of options for accessing information and enhancing their educational experience. The students now have access to a diverse range of digital resources that cater to various learning styles and preferences of the students. Additionally, the digital learning platform provides flexibility and accessibility, allowing students to learn at their own pace and on their own schedule. Moreover, the digital platforms enable communication, cooperation, and the distribution of course materials through video lectures, multimedia presentations, and live online discussions to create dynamic and interactive learning environments.

When the students use a conventional digital learning platform, feedback is upon the completion of a set questions to aid the progress of the students. The delayed feedback can present significant challenges for students, especially if they need help with something specific or if looking for guidance in real-time. The delay in getting help can make it hard for the students to learn effectively. The conventional digital learning platform uses fixed ways to give information and adjust the difficulty level of learning. Even though there have been improvements in making learning more interactive, like using simulations. The simulations provide a virtual environment that replicate real-world phenomena, allowing students to explore complex concepts in a controlled and immersive setting. For example, during learning of a projectile motion, students may use a simulation to explore the principles of projectile motion. As they adjust parameters such as angle and velocity, they observe the resulting trajectory of the projectile in real-time. But the availability of the simulation integrated within the digital learning platform is limited.

Moreover, the conventional digital learning platform gives the same materials to everyone, without considering the pattern of individual goals as each individual student has different ways to learn and still relies on a one-size-fits-all model. However, the conventional digital learning platform often uses examples and comparisons that might not be understood by every student. This can make students disconnected from the digital learning platform thereby making them less interested in the session.

### SUMMARY

In one embodiment, a method includes integrating an enhanced communication module within an online tutoring platform to integrate communication between the online tutoring platform and an artificial intelligence (AI) tutoring system to:
i) receive a user data including at least one topic of interest of the user; and
ii) collect an ongoing session data while the user is logged into the online tutoring platform, wherein the ongoing session data is utilized to understand context of the session;

The method further includes receiving the user data and the ongoing session data by the AI tutoring system to:
i) parse the received user data and session data to extract one or more session events, context related to the ongoing session, and interests of the user;
ii) compare the one or more session events to a plurality of pre-defined rules; and
iii) detect the session event matching with at least one of the pre-defined rules;
iv) generate a prompt including contextual explanation related to the ongoing session and an analogy based upon the interests of the user;
v) sending the generated prompt to the online tutoring platform; and
vi) displaying the prompt to the user via a chatbot window on a user interface of the online tutoring platform.

In one embodiment, a system includes an enhanced communication module integrated within an online tutoring platform to integrate communication between the online tutoring platform and an artificial intelligence (AI) tutoring system to:
i) receive a user data from a user, wherein the user data includes at least one topic of interest of the user; and
ii) collect an ongoing session data while the user is logged into the online tutoring platform, wherein the ongoing session data is utilized to understand the context of the ongoing session;
a processor to receive the user data and the data related to the ongoing session, wherein the processor is configured to:
i) parse the received user data and ongoing session data to extract one or more session events, context related to the ongoing session, and interests of the user;
ii) compare the one or more session events to a plurality of pre-defined rules; and
iii) detect the session event matching with at least one of the plurality of pre-defined rules;
a LLM to generate a prompt including contextual explanation related to the ongoing session and an analogy based upon the interests of the user;
a chat handler configured to establish a continuous connection between the online tutoring platform and the AI tutoring system to send the generated prompt to the online tutoring platform; and
a chatbot window on a user interface of the online tutoring platform interface to display the generated prompt to the user.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary online tutoring platform and AI tutoring system prompt generation on environment.

FIG. 2 depicts an exemplary online tutoring platform and AI tutoring system prompt generation process.

FIG. 3 depicts an exemplary process flow to trigger prompt on an online learning platform.

FIG. 4 depicts an exemplary real-time generation of interest-centered prompts and analogies for a user.

FIGS. 5-14 depict exemplary user interface displays presented by an integrated chatbot in response to information provided by an online tutoring platform and an AI tutoring system.

FIG. 15 depicts an exemplary network environment in which the system of FIG. 1 and the process of FIG. 2 may be practiced.

FIG. 16 depicts an exemplary specially programmed computer system.

### DETAILED DESCRIPTION

An artificial intelligence (AI) tutoring environment includes an artificial intelligence (AI) tutoring system. The AI tutoring system communicates with an online tutoring platform via an enhanced communication module (ECM) is enhanced to integrate within the online tutoring platform. The integrated enhanced communication module establishes a communication between the online tutoring platform and the AI tutoring system to enhance learning experience of a user on the online tutoring platform. The AI tutoring system receives all the content that appears on a user interface of the online tutoring platform and thus the system is aware of the topic or skill the user is working on at any given moment. The AI tutoring system provides contextual explanation to the user via a chatbot integrated with the user interface of the online tutoring platform, based on the received real-time content from the online tutoring platform. For example, if the user is spending significant time and provides question answer to a question, the AI tutoring system provides a contextual explanation to help user arrive at right answer. The user can also interact with the chatbot to get guidance and real-time tutoring. The AI tutoring system receives and analyzes the user data and ongoing session data to detects the situation when the user encounters a challenge or requires support. When the system identifies that the user requires a support, the AI tutoring system generate prompts tailored to the user's specific needs and learning objectives, enhancing the effectiveness of the online tutoring platform. Moreover, the use of advanced algorithms, including machine learning and natural language processing (NLP), ensures that the prompts generated by the AI tutoring system are contextually relevant and aligned with the user's unique learning style and level of understanding. The personalized approach facilitates deeper engagement with the ongoing session. The AI tutoring system is designed to cater the needs of each user to improve the learning outcomes.

Additionally, the integration of an AI engine, such as an AI engine utilizing a Large Language Model (LLM), further enhances the ability to generate prompts. The utilization of LLM enable the AI tutoring system to provide rich and informative prompts that go beyond simple instructions, offering insightful explanations, examples, and elaborations tailored to the specific requirements of the user. Furthermore, the utilization of the chatbot window as the interface for displaying the generated prompts enhances the accessibility and usability of the online tutoring platform. The chatbot window provides a user-friendly and intuitive means of interaction, allowing users to easily access instructional support and guidance provided by the AI tutoring system during the ongoing session. The chatbot window also provides a real-time communication channel that facilitates seamless communication between the user and the AI tutoring system, enabling prompt to be displayed with clarity. Additionally, the chatbot window also enables the user to post any query encountered during the session.

Overall, the AI tutoring system offers a dynamic and personalized learning experience that empowers users to achieve their learning goals more effectively. By leveraging user data, advanced algorithms, and Large Language Model, the AI tutoring system provides tailored prompts and instructional support that enhance engagement, comprehension, and overall learning outcomes. With proactive approach to problem-solving and real-time feedback mechanisms the AI tutoring system facilitates uninterrupted completion of the ongoing learning session on the online tutoring platform for the user.

Prompts are used to guide and constrain each AI engine. The prompts guide each AI engine by steering the AI engine(s). “Guiding” an AI engine refers to providing the AI engine with a general direction or enhanced communication module to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

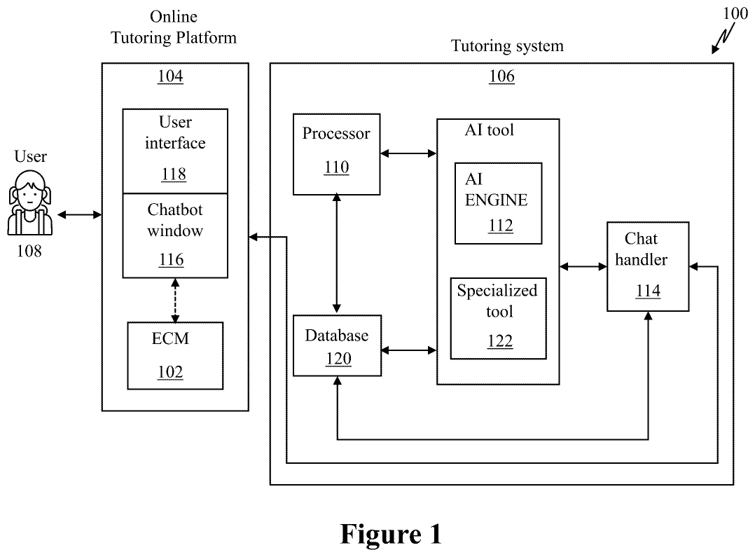

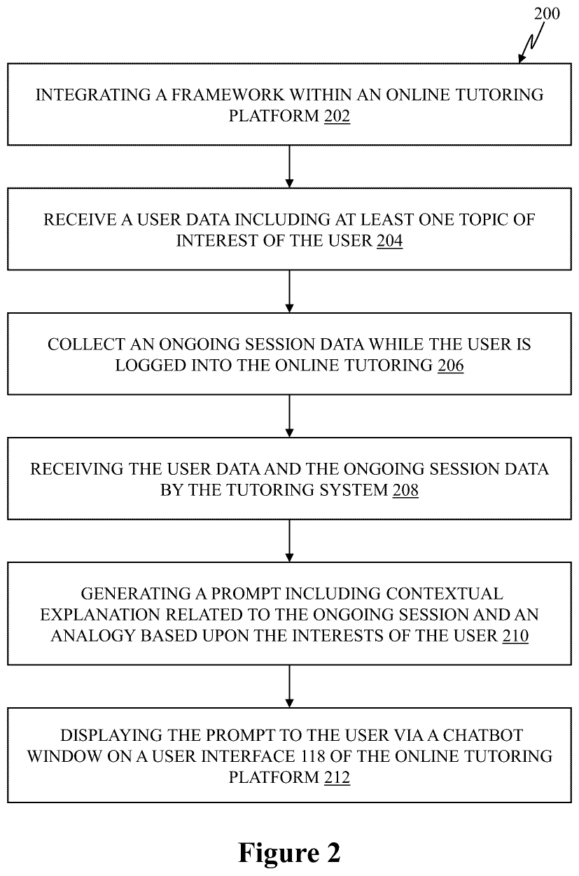

FIG. 1 depicts an exemplary AI tutoring system and prompt generation environment 100 to generate one or more real-time prompts while a user is using an online tutoring platform 104. FIG. 2 depicts an exemplary prompt generation process 200 utilized by the online tutoring environment 100.

Referring to FIGS. 1 and 2, in operation 202, an enhanced communication module 102 is integrated within the online tutoring platform 104 to initiate communication between the online tutoring platform 104 and the AI tutoring system 106. The enhanced communication module 102 is a software program, such as a web browser extension or plug-in, that extends the functionality of the web browser enabling the interaction with the online tutoring platform 104. The enhanced communication module 102 is designed to integrate with web browsers including Google Chrome, Microsoft Edge, Mozilla Firefox, Safari. The online tutoring platform 104 serves as the digital environment where educational content is hosted and delivered. The online tutoring platform can be IXL, Aleks, Commonlit, eGumpp, Khan Academy, ReadTheory, Courseware, Duolingo, Seneca and the like. The integration of the enhanced communication module 102 within the online tutoring platform 104 implies embedding the existing architecture of the online tutoring platform 104 with the enhanced communication module 102 to enable seamless interaction with the AI tutoring system 106. The AI tutoring system 106 is a software mechanism that provides real-time adaptive tutoring, contextual content delivery, interactive problem-solving guidance, generating interest-centered examples, and helping user 108 to understand where help was needed. The user 108 may be a student, teacher, or any person associated with the user. The user 108 logs into the online learning platform 104 through a user device. The user device includes a computer, desktop, mobile device or any other device that is capable of using internet and can access the online tutoring platform 104. Upon authentication, the user 108 can log in to the online tutoring platform 104. Typically, the authentication involves the user 108 providing credentials. The credentials may be for example, username and password associated with the online tutoring platform 100. After a successful login, the session is started. The session refers to a period of interaction that the user 108 engages on the online tutoring platform 104, such as solving a problem, completing an assessment, reading through the concept of a lesson and the like.

In operation 204, the AI tutoring system 108 receives user data from the user 18, wherein the user data includes at least one topic of interest of the user. The AI tutoring system 106 is engaged in acquiring the user data from the user 108. The user data is the information provided by the user, including preferences of the user, interest of the user, or other relevant details associated with the user. The user data is transferred from the user 108 to the AI tutoring system 106. Notably, the user data being received is characterized by containing at least one topic of interest indicated by the user. Typically, during the integration of the enhanced communication module 102 on the online tutoring platform 104 the user 108 provides the at least one topic of the interest. The topic of interest enables the online tutoring system 104 to provide the explanation associated with the topic of interest to the user 108 during the online session on the online tutoring platform to understand the topic in easy manner. For example, by default the topic of interest is set to the videogames, however the user at any point of time can change the topic of interest from videogame to any preferred topic. The online system 106 is configured to identify any change in the topic of interest and thereby utilize the information for further processing.

In operation 206, the AI tutoring system 108 collects data related to an ongoing session while the user is logged into the online tutoring platform 104, the ongoing session data is utilized to understand the context of the ongoing session. Within the enhanced communication module 102 of the system 100, as the user 108 engages with the AI tutoring system 106 while logged in, the data corresponding to the session is generated and captured in real-time. The data of the session includes topics of discussion, the user's interactions with the system, the overall engagement of the user 108 on the online tutoring platform 106, and the time spent by the user 108 to answer the question. Typically, the AI tutoring system 106 is configured to capture the question displayed on the online tutoring platform 104, capture the answer provided by the user corresponding to the displayed question and time taken by the user 108 to provide the answer. Furthermore, the data encompasses whether the user 108 has failed to respond to the displayed question for a duration exceeding 60 seconds. The AI tutoring system 106 ensures that the data gathers all the information required for the processing. By recording both the questions posed and the answers provided by the user 108, the online tutoring platform 104 can track the progression of the session and understand the context of the interaction of the user 108 and the topic of discussion. The data serves as valuable feedback for the AI tutoring system 106 to generate tailored assistance and question explanations relevant for each unique user. Furthermore, analyzing the data of the ongoing session data allows the online tutoring platform 104 to identify areas of difficulty for the user 108 and optimize its teaching methodologies accordingly. Furthermore, the data collected enhances the ability of the system 100 to deliver personalized and targeted support to the user 108 during the online session.

The data is collected in real-time to enhance the user experience on the online tutoring platform 104. The AI tutoring system 106 gains understanding of the context in which the user 108 is learning. The context includes not only the subject matter being studied but also the user's preferences, learning style, and any challenges or queries they may encounter during the online session. The information of context enables the AI tutoring system 106 to generate tailored responses and interventions in a manner that is highly personalized and responsive to the needs of the user 108. Moreover, the continuous gathering and analysis of the data enable the AI tutoring system 106 to adapt and evolve over time. By tracking patterns of user 108 behavior, identifying areas of difficulty, and recognizing successful instructional strategies. This iterative process of optimization ensures that the online tutoring platform 104 remains dynamic and adaptive, to deliver effective and relevant support to the user 108.

In operation 208, the user data and the data related to the ongoing session is received by a processor 110 of the AI tutoring system 106. Upon receiving user data and the data related to the ongoing session, the processor 110 initiates a parsing procedure to extract one or more session events from the user data and the data related to the ongoing session. The parsing procedure involves systematic analysis and extraction of relevant session events from the combined dataset of user data and the data related to the ongoing session. The processor 110 of the AI tutoring system 106 is configured to selectively extract one or more session events from the user data and the data related to the ongoing session. The extracted one or more session events allows the AI tutoring system 106 to track and monitor the progression of the user 108 during the online session in real-time. The one or more session events includes action taken by the user such as providing the answer, time taken by the user 108 to provide the answer and the user 108 requesting the online tutoring platform 104 for additional assistance. By analyzing the extracted one or more session events the patterns of the user behavior, interactions, and preferences are identified. Moreover, the processor 110 allows the AI tutoring system 104 to gain insights of the areas of focus for the user 108 to generate responses that help the user 108 in learning. In this regard, the AI tutoring system 106 provides a personalized approach that enhances the effectiveness of the system 100 by ensuring the constant assistance is provided to the user 108.

Once the one or more session events has been extracted, the processor 110 is configured to compare the one or more session events to a plurality of pre-defined rules. The plurality of pre-defined rules are the guidelines for defining various events within the AI tutoring system 106 where the intervention is required. The plurality of pre-defined rules includes: when user 108 spends more than 60 seconds on the online learning platform 104 without answering the question or when the user 108 provides a wrong answer. Moreover, the processor 110 is configured to compare the one or more session events to the plurality of pre-defined rules to detect an event matching with at least one of the plurality of pre-defined rules. The comparison involves evaluating each session event against a plurality of predefined rules to detect a match. The processor 110 is also configured to detect the event that matches with at least one of the plurality of predefined rules. The session event from the one or more session events that match with at least one of pre-defined rule from the plurality of the pre-defined rules is considered to be relevant based upon which a prompt will be generated and the rest of the session events are neglected.

In operation 210, an AI engine 112 utilizing, for example, an LLM, generates a prompt including contextual explanation related to the ongoing session and an analogy based upon the interests of the user. The LLM serves as a powerful tool for enhancing the learning experience by generating prompts that provide contextual explanations tailored to the ongoing session and user data. Generating the prompt involves analyzing the session, including the topics being discussed, the user's interactions, and any relevant contextual information available. The AI engine 112 includes AI engines, such as ChatGPT by OpenAI, Microsoft Co-Pilot, and so on. The AI engine 112 generates prompts that offer insightful explanations, clarifications, or additional information related to the ongoing session incorporating the user topic of interest to generate the prompts, thereby enriching the understanding and facilitating engagement with the user 108. The AI engine 112 provides a personalized prompt associated with the user topic of interest thereby making the prompts relatable and engaging for the user 108. For example, if a user has an interest in sports, the LLM may generate analogies or examples related to sports to illustrate complex concepts or principles being discussed during the session. The AI engine 112 is configured to generate immersive and personalized prompts by drawing upon the interest, to foster interest and motivation in the user 108. Typically, the prompt is the textual support provided by tutoring system 106 to help the user 108 to solve the question or understand the concept of the topic. The prompt resonates with the personal experiences or preferences of the user 108. However, in at least one embodiment, the prompt generated does not disclose the answer of the displayed question but only assist the user to identify the answer by providing various cues and explanation through the prompts.

A chat handler 114 configured to establish a continuous connection between the online tutoring platform 104 and the AI tutoring system 106 to send the generated prompt to the online tutoring platform 104. The chat handler 114 is responsible for managing the flow of messages and serves as a bridge, ensuring that the generated prompt is routed to the user 108. Upon the generation of the prompt, the chat handler 114 facilitates the transmission of the generated prompt to the online tutoring platform 104. The chat handler 114 facilitates the transmission of generated prompts from the AI tutoring system 106 to the online tutoring platform 104 in real-time. This communication mechanism ensures prompt delivery of instructional content, including contextual explanations, analogies, or instructional guidance, to users engaged in the sessions via the online tutoring platform 104. The chat handler 114 is configured to establish a persistent communication channel, enabling seamless data exchange between the online tutoring platform 104 and the AI tutoring system 106. Through the continuous connection, the chat handler 114 facilitates efficient and reliable transmission of prompts, ensuring timely delivery of instructional content to the user 108 during the online session.

In at least one embodiment, the chat handler 114 may utilize standard networking protocols and communication standards to establish and maintain the connection between the AI tutoring system and the online tutoring

platform. These protocols may include Application programming interface (API), Transmission Control Protocol (TCP), User Datagram Protocol (UDP), or Hypertext Transfer Protocol (HTTP). The chat handler 114 ensures compatibility and interoperability with existing network infrastructure and online tutoring platform 104. The chat handler 114 may incorporate security features to protect sensitive data transmitted between the AI tutoring system 106 and the online tutoring platform 104. This may include encryption techniques to secure data in transit, ensuring confidentiality and integrity of user information. The enhanced communication module is integrated to the online tutoring platform 104 via one or more endpoints including APIs of the online tutoring platform 104 that enables the connection between the online tutoring platform 104 with the AI tutoring system 106 The one or more endpoints enables the online tutoring platform 104 to interact with the AI tutoring system 106 to provide bidirectional communication therebetween.

In at least one embodiment, the enhanced communication module 102 is integrated to the online tutoring platform 104 via one or more endpoints including APIs of the online tutoring platform 104 that enables the connection between the online tutoring platform 104 with the AI tutoring system 106 The one or more endpoints enables the online tutoring platform 104 to interact with the AI tutoring system 106 to provide bidirectional communication therebetween. Typically, the one or more endpoints is utilized to send the generated prompt from the AI tutoring system 106 to the online tutoring platform. Advantageously, the chat handler 114 may incorporate intelligent routing capabilities to optimize data transmission paths between the AI tutoring system 106 and the online tutoring platform 104. By analyzing network topology, latency, and other factors, the chat handler 114 can dynamically select the most efficient communication routes, minimizing latency and maximizing throughput.

In operation 212, displaying the prompt to the user 108 via a chatbot window 116 on a user interface 118 of the online tutoring platform 104. The chatbot window 116 serves as an interface through which the user 108 can receive instructional content, including contextual explanations, analogies, or instructional guidance, during the session. The chatbot window 116 is prominently displayed within the user interface 118 of the online tutoring platform 104, ensuring visibility and accessibility for the user 108 engaged in session. In at least one embodiment, the chatbot window 116 may be designed to be collapsible or resizable, providing user 108 with flexibility in customizing their viewing experience based on their preference and screen size of the user device. Alternatively, the chatbot window 116 may be positioned in a fixed location on the user interface 118, such as at the bottom or side of the screen, allowing users to easily access prompts without disrupting their ongoing interactions with the online tutoring platform 104. In at least one embodiment, the chatbot window 116 is equipped with interactive features that enable the user 108 to engage with the generated prompts and interact with the AI tutoring system 106 in real-time. The user 108 may input queries directly into the chatbot window 116, to initiate further interactions with the AI tutoring system 106 for seeking additional assistance if required to enhance the experience of the user 108. The user 108 at any point of time during the ongoing session may ask the question that is relevant to the display question on the user interface 118 of the online tutoring platform 104, however, the AI tutoring system 106 analyze the asked question to identify the need of the user in order to generate the prompt that is easily understood by the user 108.

In at least one embodiment, the chatbot window 116 is configured to display prompts generated by the AI tutoring system 106 in a clear and visually appealing format. The generated prompts may be presented as text-based messages, accompanied by relevant images, icons, or other visual elements to provide context. The chatbot window 116 may also support formatting options such as bold, italic, or underline text, allowing for emphasis on key points or concepts within the prompts. Furthermore, the chatbot window allows the user 108 to scroll through previous prompts, view the conversation history, or access additional resources directly from the chatbot window, enhancing the usability and convenience of the online tutoring platform 104. Additionally, the chatbot window 116 may include search functionality, allowing users to quickly locate specific prompts or topics of interest within their conversation history.

In at least one embodiment, the chatbot window 116 may employ natural language processing (NLP) techniques to interpret the queries and responses of the user 108, enabling seamless communication and interaction with the AI tutoring system 106. The chatbot window 116 may also utilize machine learning algorithms to personalize prompts based on user preferences, learning styles, or historical interactions, enhancing the relevance and effectiveness of instructional content delivered to the user 108.

In at least one embodiment, the system 100 comprises a database 120 for storing the data, user data, extracted events and generated prompts. The stored user data stored within the database 120 encompasses information related to user profiles, preferences, and interaction history including educational background, learning preferences, and past session data. The system 100 utilizes the user data to deliver targeted and customized examples to optimize user 108 engagement and learning. Moreover, the database 120 stores generated prompts generated by the AI tutoring system 106. The prompts comprises instructional content, contextual explanations, analogies, and interactive exercises designed to support the user 108 is stored in the database 120 in order to retrieve and deliver relevant content to users in response to stored data, thereby enhancing the overall user experience. Furthermore, the database 120 ensures the confidentiality of the stored data by employing encryption techniques, access controls, and data backup procedures to safeguard sensitive information and mitigate the risk of unauthorized access or data loss. Furthermore, the database 120 employs data backup procedures as a proactive measure to mitigate the risk of data loss and ensure data resilience. In the event of a system failure, data corruption, or accidental deletion, these backup copies can be readily accessed and restored, ensuring continuity of operations of the online tutoring platform 104.

To effectively manage the computational demands, the load balancing and distributed processing mechanisms are implemented. The load balancing involves the distribution of tasks across multiple computing resources to optimize resource utilization and ensure efficient operation. By distributing tasks evenly across available resources, load balancing minimizes the risk of resource bottlenecks. Furthermore, distributed processing techniques enable the system 100 to leverage the collective computing power of interconnected devices or nodes within a network to execute computational tasks in parallel to accelerate data analysis, prompt generation, and content delivery, thereby reducing processing latency and enhancing system throughput.

Moreover, load balancing and distributed processing techniques enables the dynamic nature of the system computational workload to dynamically adjust task allocation based on ongoing condition. For example, one user submits a question, triggering the AI tutoring system to generate a prompt. Simultaneously, another user is also engaged in the online session, requiring prompt generation based on their session context. Additionally, several other users are accessing the online tutoring platform, each contributing to the overall computational workload with their respective interactions. In this scenario, the computational demands of the system for real-time data analysis, response generation, and personalized content delivery may vary significantly based on factors such as user activity, session complexity, and system load. To effectively manage these computational demands, the system implements load balancing and distributed processing mechanisms.

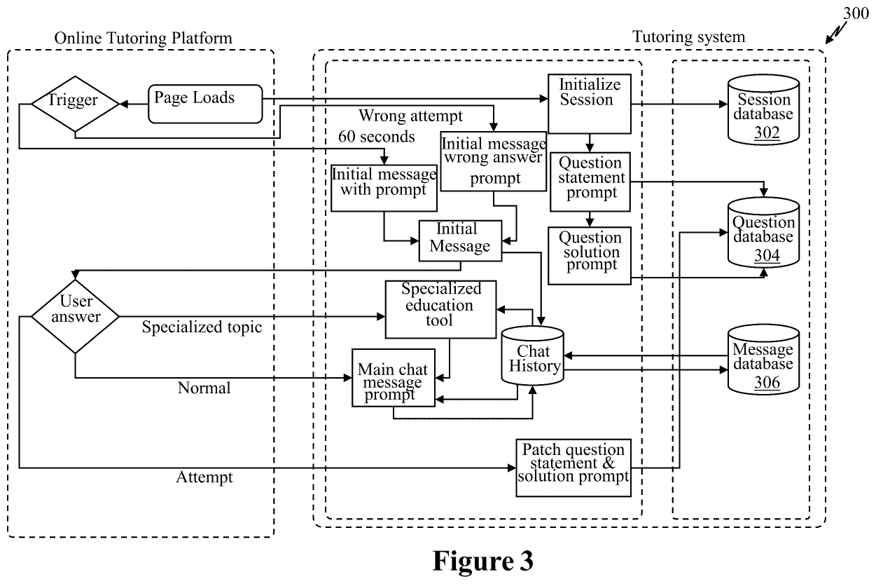

FIG. 3 depicts an exemplary process flow to trigger prompt on the online learning platform 106. As shown, when the user 108 logs on the online learning platform 106, the online session is initiated. The enhanced communication module 102 integrated on the online tutoring platform 104 establishes communication between the online tutoring platform 104 and the AI tutoring system 106. The details pertaining to the ongoing session is stored on a session database 302. The prompt generation occurs under various conditions, including when the user 106 submits an incorrect answer to a question displayed on the user interface 118 of the online tutoring platform 104, or when the user spends 60 seconds on the online tutoring platform 104 without providing an answer to a displayed question as explain n FIG. 1 and FIG. 2. The data related to the question displayed on the online tutoring platform, user answer corresponding to the displayed question, and recording timestamps related to question display and user input are stored in a question database 304.

Additionally, the AI tutoring system analyzes the question displayed on the user interface 118 to identify when the question is related to a specialized topic. The specialized topic includes subjects such as mathematics, science, and social science. If the question is related to the specialized topic, the question is sent to a specialized education tool 122 as depicted in FIG. 1. The specialized education tool 122, include Wolfram Validation and the like. The specialized education tool 112 analyzes the question and generates the prompt without disclosing the answer to the user 108. is employed for prompt generation. Conversely, if the question pertains to a topic outside the specialized topic, the prompt is directly generated by the AI engine 112. The AI tutoring system 106 monitors user responses to the displayed questions. If the user submits an incorrect answer, indicative of potential comprehension difficulties, or spends an extended period of time without responding to a question, triggers to provide the prompt to the user 108. Capturing the question displayed on the online tutoring platform 104 enables the AI tutoring system 106 to personalize prompts based on the content being addressed and the topic of interest of the user 108 to with user preference. Furthermore, the utilization of specialized education tool 122 for prompt generation for the specialized topic allows the AI tutoring system 106 to adapt to cater diverse learning requirements of the user 108. The prompts generated are stored in a message database 306 throughout the session of each user. The AI tutoring system 106 enhances the accuracy of instructional support provided to user 108, particularly in complex subject areas where specialized expertise is required. Furthermore, collectively the session database 302, question database 304 and a message database 306 are stored in a single database for data privacy in the database 120.

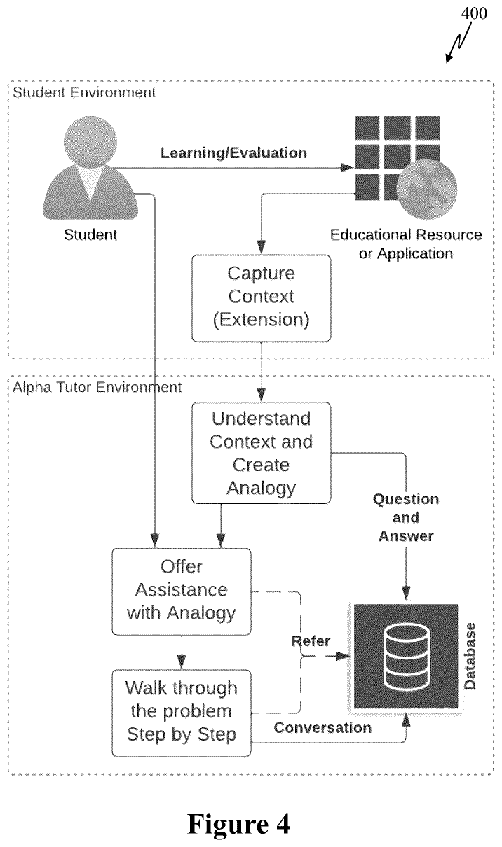

FIG. 4 is an exemplary real-time generation of interest-centered examples and analogies 400. The user 108 logs into the online tutoring platform 104, initiating a sequence of interactions facilitated by the enhanced communication module 102 integrated within the online tutoring platform 104. The enhanced communication module 102 transmits contextual information from the user 108 to the AI tutoring system 106 generating assistance with analogies and examples. Upon receiving the context through the enhanced communication module 102, the AI tutoring system 106 analyzes the received information and offers assistance with the generation of analogies and examples. The AI tutoring system 106 operates in real-time, dynamically generating prompts based on the contextual cues provided by the user 108. Typically, the contextual information includes the question displayed on the online tutoring platform 104 and any relevant user inputs or interactions, which the AI tutoring system 106 utilizes to tailor the assistance accordingly. By synthesizing the contextual data, the AI tutoring system 106 generates analogies and examples that resonate with the interest of the user 108.

Moreover, the question displayed on the online learning platform 106, the context received through the enhanced communication module 102, and the generated prompts with analogies and examples, are stored in the database 120. Additionally, the database 120 stores contextual information from each session, interests, and learning patterns of the user 108 that helps the AI tutoring system 106 to generate the tailored prompts for each user.

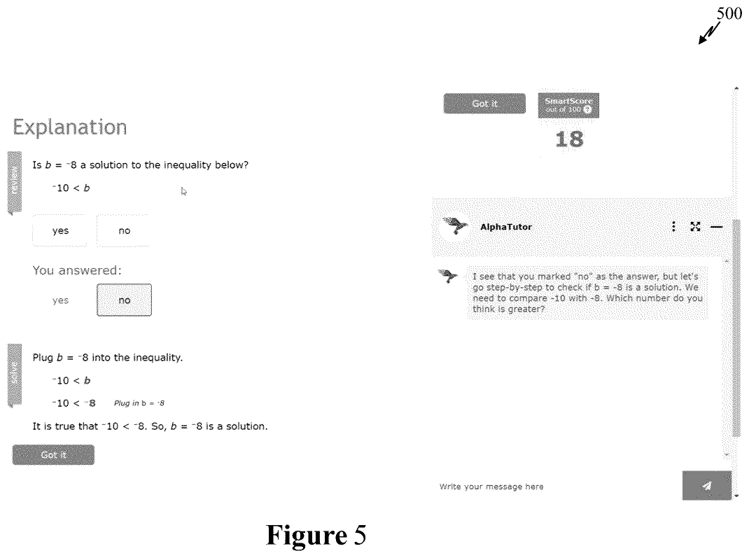

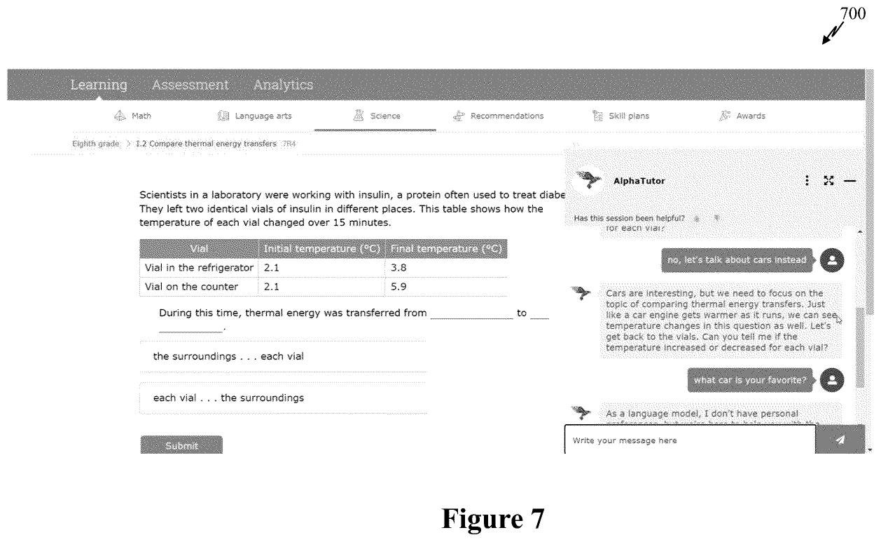

FIGS. 5-14 depict exemplary user interface displays presented by an integrated chatbot 116 in response to information provided by the online tutoring platform 104 and an AI tutoring system 106. Referring to FIG. 5, the user interface 118 integrated with the online tutoring platform 104, wherein the user 108, interacts with the content displayed on the online tutoring platform 104 and attempts a question presented on the online tutoring platform 104. In the event the user 108 enters an incorrect answer to a question posed by the online tutoring platform 104, the chatbot window 116 is automatically triggered and displayed within the user interface 118. The chatbot window 116 provides a dynamic and interactive interface to assist and guide the user 108. Upon the submission of an incorrect answer by the user 108, the chatbot window 116 is immediately popped up within the user interface 118, presenting users with the prompt for providing clarification and understanding of the explanation provided by the online tutoring platform 104 based on the displayed question. In operation, the prompt provided on the chatbot window 116 offers real-time explanations and instructional support to the user 108 and helps the user 108 to understand the explanation as provided on the online tutoring platform 104.

Moreover, the chatbot window 116 provides two-way communication between the online tutoring platform 104 and the user 108. Furthermore, the chatbot window 116 allows the user to interact with the online tutoring platform 104 by asking questions, requesting further clarification, thereby fostering active participation and deepening the understanding of the subject matter of the user 108. In addition, when user 108 spends more than 60 seconds to answer the question displayed on the online tutoring platform 104, the chatbot window 116 is also triggered with the prompt and displayed on the user interface. The prompt provides assistance for the user 108 encountering difficulties or prolonged hesitation during question-solving processes. The chatbot window 116 triggers with relevant prompts associated with the question to help the user to solve the question allowing the online tutoring platform to enhance engagement with the user 108.

The below is data structure to display the prompt to the user on the user interface of the online tutoring platform:

```
Real-Time Adaptive Tutoring System
  # Function to assess student input and provide immediate feedback
  function assess_and_respond(student_input):
      # Analyze the student's input to determine the difficulty they are
facing
      difficulty = analyze_input(student_input)
      # Generate a response based on the identified difficulty
      response = generate_response(difficulty)
      # Provide the generated response to the student
      return response
# Function to analyze student input
function analyze_input(input):
      # Use NLP algorithms to understand the input
      # Reference to codebase: NLP processing module
      parsed_input = nlp_process(input)
      # Determine the nature of the difficulty
      difficulty = determine_difficulty(parsed_input)
      # Return the difficulty assessment
      return difficulty
# Function to generate a response based on difficulty
function generate_response(difficulty):
      # Use adaptive algorithms to tailor the response
      # Reference to codebase: Adaptive response generation module
      response = adaptive_algorithm(difficulty)
      # Return the tailored response
      return response
```

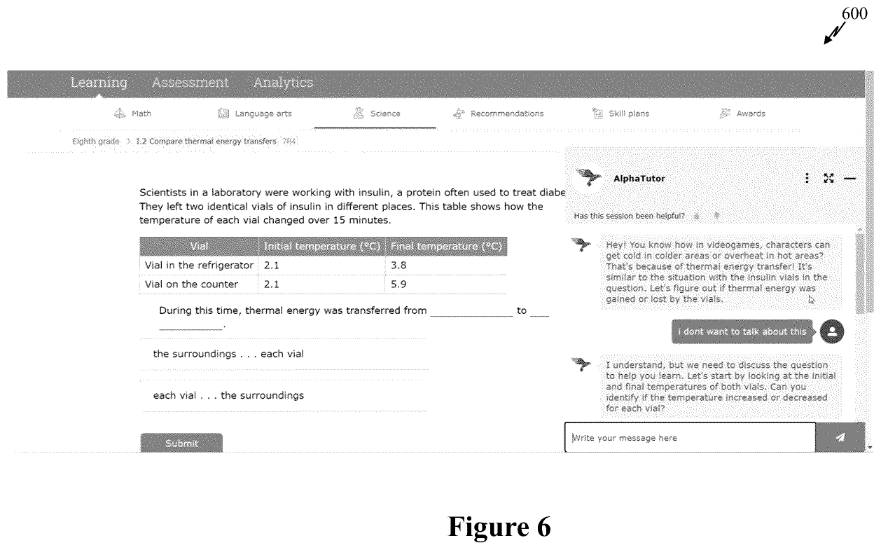

FIGS. 6-8 depict exemplary user interfaces 600, 700, 800, depicting interaction between the user 108 and the chatbot window 116 on the online learning platform 104. As shown in FIGS. 6-8 collectively, the user 108 attempts to steer the conversation with the chatbot window 116 away from the learning exercise or question presented on the online learning platform 104. However, the chatbot window 116 consistently focuses on generating prompts associated with the ongoing learning exercise or the question displayed on the online learning platform 104. The online tutoring system 106 is configured to maintain focus and relevance within the educational context, despite attempts by the user 108 to deviate from the intended subject matter as shown in FIGS. 6-8. The online tutoring system 106 ensures that user 108 receives consistent and personalized prompts based on the interest of the user 108.

In operation, the AI tutoring system 106 employs advanced natural language processing (NLP) algorithms and machine learning techniques to interpret input of the user 108 and identify whether the input of the user 108 is relevant for the ongoing learning exercise or question. Moreover, based on the input of the user 108 the prompt is generated to provide relevant instructional guidance aligned with the learning objectives of the user 108. Additionally, the prompts displayed on the chatbot window 116 does not deviate from the session, instead generated prompts are in line with the ongoing learning exercise or displayed question. The chatbot window 116 ensures that user 108 receives timely and pertinent assistance from the AI tutoring system 106 on the online learning platform 104 based on the preference of the user 108.

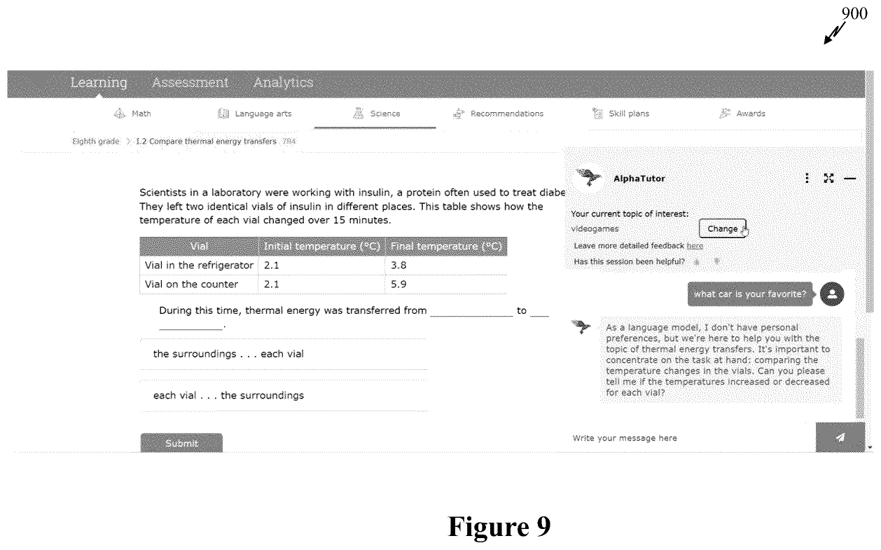

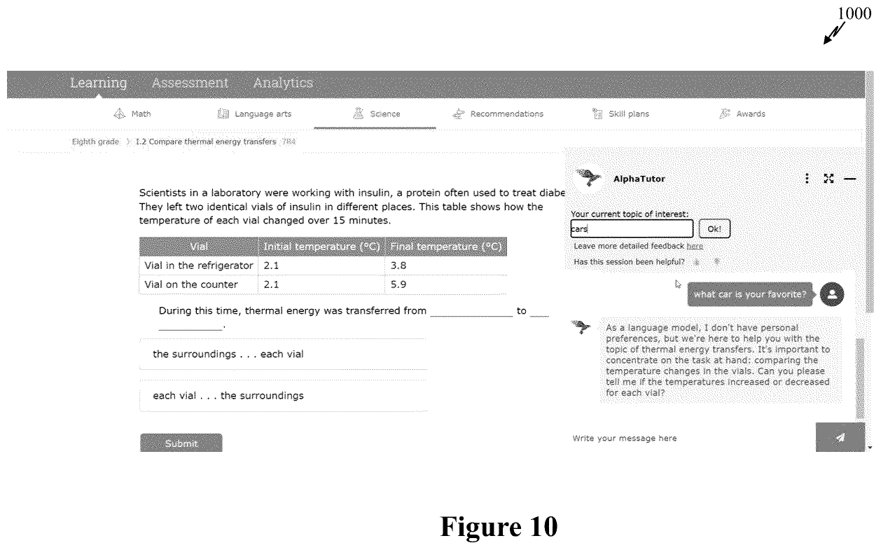

Referring to FIGS. 9-11, exemplary user interfaces 900, 1000, 1100 depicting interaction between the user 108 and the chatbot window 116 are shown. Referring to FIG. 9, the AI tutoring system 106 initially sets to a predefined topic of interest, for example herein by a videogame. The predefined topic of interest enables the user 108 to receive prompts tailored to the ongoing session with analogies drawn from the videogames. The utilization of such analogies aids in contextualizing the instructional material, making it more relatable and engaging for the user 108. Referring to FIG. 10, the user 108 can modify the topic of interest at any time during the session. Upon modifying the topic, the AI tutoring system 106 dynamically adjusts the generated prompts to align with the newly selected topic of interest. For example, here the modified topic of interest is cars. This allows the AI tutoring system 106 to generate prompts incorporating analogies relevant to the changed interest, thereby ensuring that the generated prompt is associate with cars during the explanation regarding the learning exercise or question

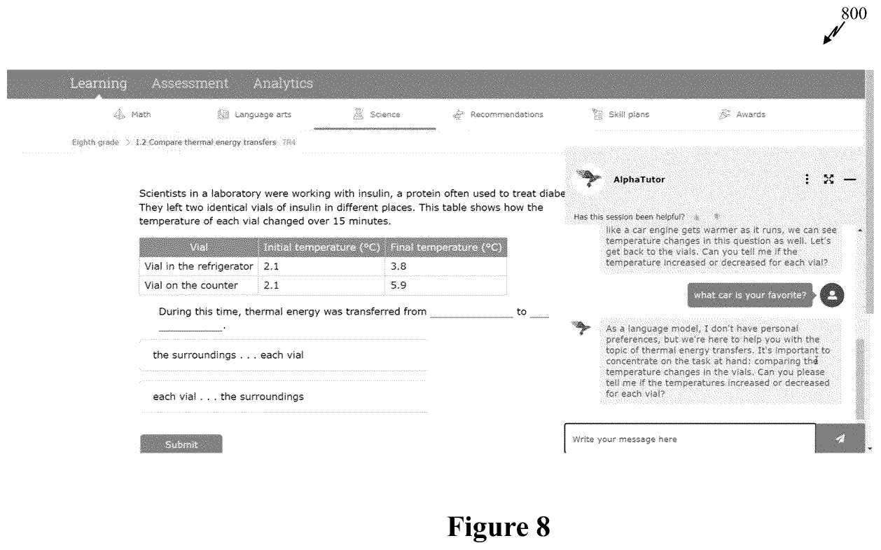

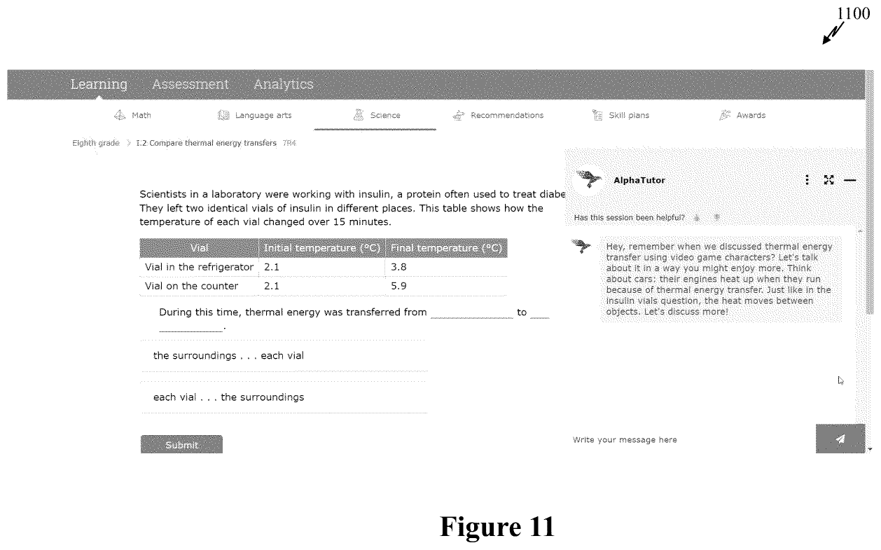

Referring to FIG. 11, the AI tutoring system 106 stores the information regarding the initial topic of interest and the modified topic of interest updated by the user 108 allowing the AI tutoring system 106 to effectively utilize the stored data during the conversation with the user 108, facilitating personalized and adaptive learning experiences tailored to the user preference. As shown in FIG. 8, the initial topic of interest of the user 108 is “videogames”, which is modified by the user 108 to “cars” as depicted in FIG. 10. As the chat handler 116 in FIG. 11, displays the prompt generated based on the modified topic of interest, however, also mentions the initial topic of interest. The AI tutoring system 106 stores the records of the topic of interest of the user 108. Furthermore, the AI tutoring system 106 dynamically updates any change of topic of interest made by the user 108 during the session thereby maintaining a comprehensive record of conversation data of the user with the online learning platform 104.

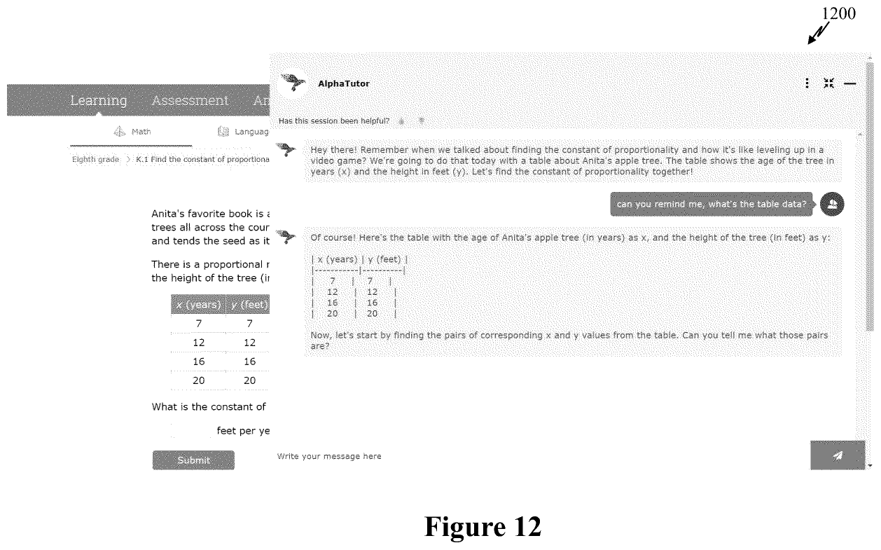

FIG. 12 shows exemplary user interface 1200 depicting resizable chatbot window 116 of the online tutoring platform 104 by the user 108. The chatbot window 116 of the online tutoring platform 104 is resizable that allows user 108 to dynamically adjust the size of the chatbot window 116 in response to the generated prompt displayed on the user interface 118. By enabling the user 108 to customize the size of the chatbot window 116, the system 100 enhances user experience and facilitates optimal utilization of the screen of the user device during tutoring session. Upon receiving the generated prompt, the user 108 can resize the chatbot window 116 to display comprehensive content such as tables and other relevant prompts that require a greater screen space for presentation. The user 108 adjusts the size of the chatbot window 116 allowing complex prompts, such as tables containing detailed information or lengthy textual prompts, can be accommodated effectively within the user interface 118 of the online tutoring platform 104. Advantageously, resizing the chatbot window 116 enhances user experience by providing optimal visibility and readability of the displayed prompts. Conversely, if the prompt is brief the user 108 can resize the chatbot window 116 to a smaller dimension.

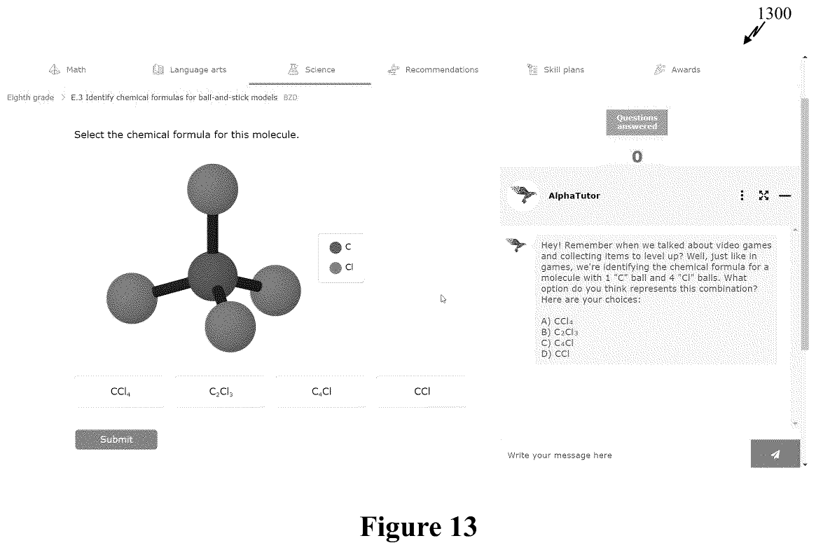

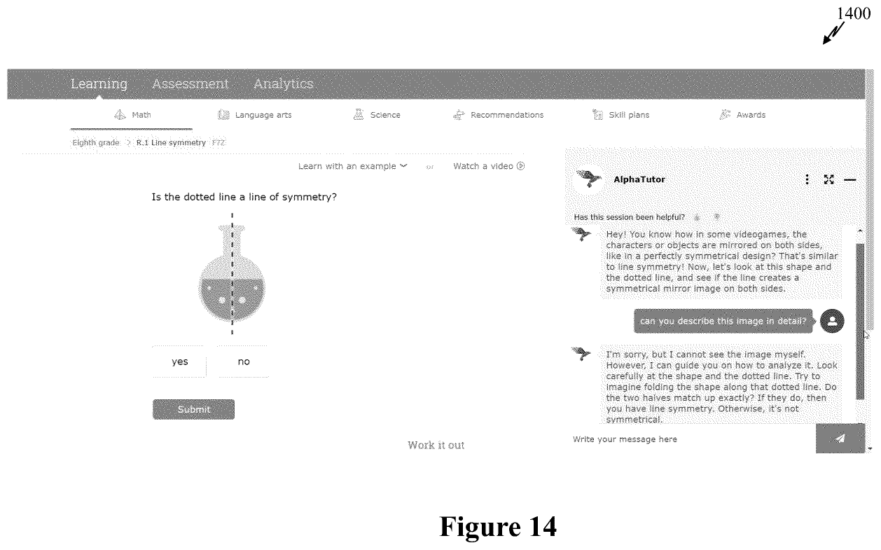

Referring to FIGS. 13-14, shown here are exemplary user interfaces 1300, 1400 depicting interpretation of chatbot window 116 when question includes an image. The chatbot window 116 does not directly interpret images present in the questions displayed on the user interface 118 of the online tutoring platform 104. Instead, the chatbot window 116 relies on textual information extracted from the question to generate prompts and generate the prompts based on the textual information to the user 108. Referring to FIG. 12, the chatbot window generates the prompt based on the topic of interest to help the user 106 to deduce the answer. In FIG. 13, the question says “select the chemical formula for the molecule” and the generated prompt based on the topic of interest and the textual information is “Hey! Remember when we talked about video games and collecting items to level up? Well, just like in games, we're identifying the chemical formula for the molecule with 1 C call and the 4 Cl balls”. The chatbot window 116 utilizes text processing to analyze the textual content of the question, extracting key concepts, keywords, and contextually relevant information. This textual analysis enables the chatbot window 116 to understand the underlying intent of the question and generate prompts that help in providing the explanation of the question to the user 108 without disclosing.

Similarly, referring to FIG. 14, the question says “Is the dotted line a line of symmetry?” Here based on the textual information the AI tutoring system 106 identifies the question is related to the symmetry hence and the generated prompt based on the topic of interest and the textual information is “Hey! you know how in some videogames, the character or objects are mirrored on both sides, like in a perfectly symmetrical design? That's similar to line symmetry! Now, let's look at the shape and the dotted line, and see if the line creates a symmetrical mirror image on both sides. Moreover, when the user 108 tries to describe the image in detail the generated prompt explains the textual information in more details.

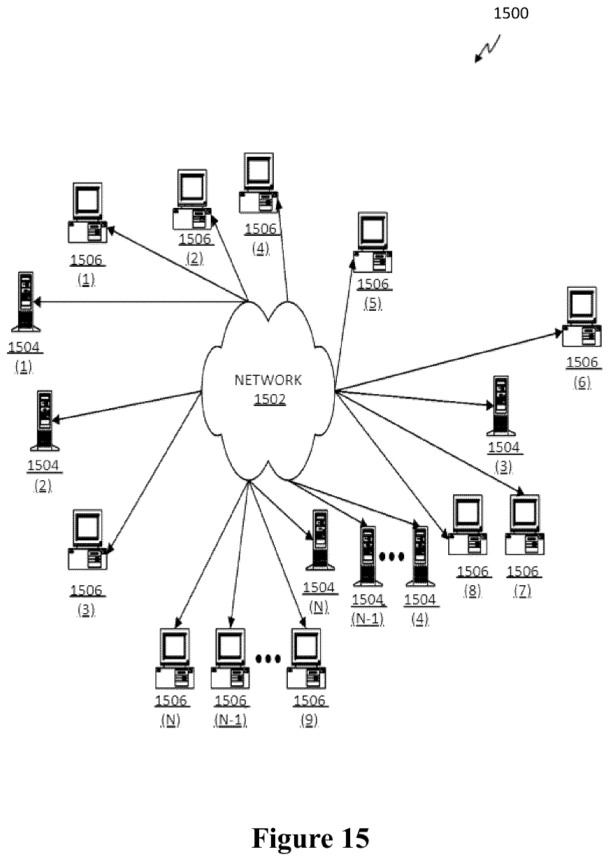

FIG. 15 is a block diagram illustrating a network environment in which a system 100 and a method 200 may be practiced. Network 1502 (e.g. a private wide area network (WAN) or the Internet) includes a number of networked server computer systems 1504(1)-(N) that are accessible by client computer systems 1506(1)-(N), where N is the number of server computer systems connected to the network. Communication between client computer systems 1506(1)-(N) and server computer systems 1504(1)-(N) typically occurs over a network, such as a public switched telephone network over asynchronous digital subscriber line (ADSL) telephone lines or high-bandwidth trunks, for example communications channels providing T1 or OC3 service. Client computer systems 1506(1)-(N) typically access server computer systems 1504(1)-(N) through a service provider, such as an internet service provider (“ISP”) by executing application specific software, commonly referred to as a browser, on one of client computer systems 1506(1)-(N).

Client computer systems 1506(1)-(N) and/or server computer systems 1504(1)-(N) are specialized computer programmed to improve conventional computer systems to implement and utilize the system 100 and the method 200. The type of computer system that can be specially programmed to implement and utilize the system 100 and the method 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the system 100 and the method 200 can be implemented using code stored in a tangible, non-transient computer readable medium and executed by one or more processors. In at least one embodiment, the system 100 and the method 200 can be implemented completely in hardware using, for example, logic circuits and other circuits including field programmable gate arrays.

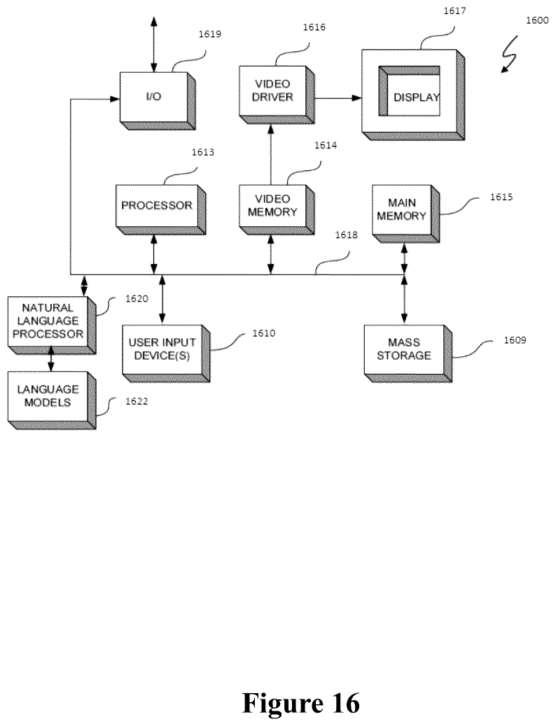

Embodiments of the system 100 and the method 200 can be implemented on a computer system such as a special-purpose, special-programmed computer 1600 illustrated in FIG. 16. Input user device(s) 1610, such as a keyboard and/or mouse, are coupled to a bi-directional system bus 1618. The input user device(s) 1610 are for introducing user input to the computer system and communicating that user input to processor 1613. The computer system of FIG. 16 generally also includes a non-transitory video memory 1614, non-transitory main memory 1515, and non-transitory mass storage 1609, all coupled to bi-directional system bus 1618 along with input user device(s) 1610 and processor 1613. The mass storage 1509 may include both fixed and removable media, such as a hard drive, one or more CDs or DVDs, solid state memory including flash memory, and other available mass storage technology. Bus 1618 may contain, for example, 32 of 64 address lines for addressing video memory 1614 or main memory 1615. The system bus 1518 also includes, for example, an n-bit data bus for transferring DATA between and among the components, such as CPU Y09, main memory 1615, video memory 1614 and mass storage 1609, where “n” is, for example, 32 or 64. Alternatively, multiplex data/address lines may be used instead of separate data and address lines.

I/O device(s) 1619 may provide connections to peripheral devices, such as a printer, and may also provide a direct connection to a remote server computer systems via a telephone link or to the Internet via an ISP. I/O device(s) 1619 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1609, into main memory 1615 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1615 is comprised of dynamic random access memory (DRAM). Video memory 1614 is a dual-ported video random access memory. One port of the video memory 1614 is coupled to video amplifier 1616. The video amplifier 1616 is used to drive the display 1617. Video amplifier 1616 is well known in the art and may be implemented by any suitable means. This circuitry converts pixel DATA stored in video memory 1614 to a raster signal suitable for use by display 1617. Display 1617 is a type of monitor suitable for displaying graphic images.

The computer system described above is for purposes of example only. The system 100 and the method 200 may be implemented in any type of computer system or programming or processing environment. It is contemplated that the system 100 and the method 200 might be run on a stand-alone computer system, such as the one described above. The system 100 and the method 200 might also be run from a server computer systems system that can be accessed by a plurality of client computer systems interconnected over an intranet network. Finally, the system 100 and method 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method comprising:
integrating an enhanced communication module within an online tutoring platform to integrate communication between the online tutoring platform and an artificial intelligence (AI) tutoring system to:
i) receive a user data including at least one topic of interest of the user; and
ii) collect an ongoing session data while the user is logged into the online tutoring platform, wherein the ongoing session data is utilized to understand context of the session;
receiving the user data and the ongoing session data by the AI tutoring system to:
i) parse the received user data and session data to extract one or more session events, context related to the ongoing session, and interests of the user;
ii) compare the one or more session events to a plurality of pre-defined rules; and
iii) detect the session event matching with at least one of the pre-defined rules;
iv) generate a prompt including contextual explanation related to the ongoing session and an analogy based upon the interests of the user;
v) sending the generated prompt to the online tutoring platform; and
vi) displaying the prompt to the user via a chatbot window on a user interface of the online tutoring platform.

2. The method of claim 1 wherein the method further comprises:
triggering a large Language Model (LLM) to generate the prompt when the user spends 60 seconds on the online tutoring platform without answering a question displayed on the user interface of the online tutoring platform interface.

3. The method of claim 1 wherein the method further comprises:
triggering a LLM to generate the prompt when the user submits a wrong answer of a question displayed on the user interface of the online tutoring platform interface.

4. The method of claim 1 further comprising:
resizing the chatbot window by the user to see the generated prompt.

5. The method of claim 1 further comprises integrating the enhanced communication module to the online tutoring platform via one or more endpoints including APIs of the online tutoring platform.

6. The method of claim 1 wherein collecting the data includes capturing the question displayed on the online tutoring platform, capturing the answer provided by the user corresponding to the displayed question, and capturing one or more timestamps related to when the question is displayed to the user and when the user inputs an answer.

7. The method of claim 1 further comprising:
parsing the ongoing session data to identify if the data is related to a specialized topic and transmitting the data to a specialized education tool for generating the prompt if the data is related to the specialized tool.

8. The method of claim 1 further comprising:
storing the user data, extracted events, topic of interest, ongoing session data and generated prompts in a database.

9. The method of claim 1 further comprising:
interpreting text of a question including at least one image, thereby generating a contextual prompt based on the question text.

10. A system comprising:
an enhanced communication module integrated within an online tutoring platform to integrate communication between the online tutoring platform and an artificial intelligence (AI) tutoring system to:
i) receive a user data from a user, wherein the user data includes at least one topic of interest of the user; and
ii) collect an ongoing session data while the user is logged into the online tutoring platform, wherein the ongoing session data is utilized to understand the context of the ongoing session;
a processor to receive the user data and the data related to the ongoing session, wherein the processor is configured to:
i) parse the received user data and ongoing session data to extract one or more session events, context related to the ongoing session, and interests of the user;
ii) compare the one or more session events to a plurality of pre-defined rules; and
iii) detect the session event matching with at least one of the plurality of pre-defined rules;
a LLM to generate a prompt including contextual explanation related to the ongoing session and an analogy based upon the interests of the user;
a chat handler configured to establish a continuous connection between the online tutoring platform and the AI tutoring system to send the generated prompt to the online tutoring platform; and
a chatbot window on a user interface of the online tutoring platform interface to display the generated prompt to the user.

11. The system of claim 10 wherein the LLM generates the prompt when the user spends 60 seconds on the online tutoring platform without answering a question displayed on the user interface of the online tutoring platform interface.

12. The system of claim 10 wherein the LLM generates the prompt when the user submits a wrong answer of the question displayed on the user interface of the online tutoring platform interface.

13. The system of claim 10 wherein the chatbot window is resizable.

14. The system of claim 10 wherein the enhanced communication module is integrated to the online tutoring platform via one or more endpoints including APIs of the online tutoring platform.

15. The system of claim 10 wherein the enhanced communication module collects the data related to the ongoing session including, capturing the question displayed on the online tutoring platform, capturing the answer provided by the user corresponding to the question displayed, and capturing one or more timestamps related to when the question is displayed to the user and when the user inputs an answer.

16. The system of claim 10 further comprising.
a specialized education tool for generating the prompt when the data of the ongoing session on the online tutoring platform is related to a specialized topic.

17. The system of claim 10 further comprising.
interpreting text of a question including at least one image, thereby generating a contextual prompt based on the question text.

18. The system of claim 10 further comprising.
a database to store user data, extracted events, topic of interest, ongoing session data and generated prompts.
